(19) United States
(12) Patent Application Publication
(10) Pub. No.: US 2005/0086189 A1
(43) Pub. Date: Apr. 21, 2005

(54) Systems and methods for evaluating a collaboration level among team members

(75) Inventor: David F. Noble, Vienna, VA (US)

Correspondence Address: OLIFF & BERRIDGE, PLC, P.O. BOX 19928, ALEXANDRIA, VA, 22320, US

(73) Assignee: EVIDENCE BASED RESEARCH, INC., Vienna, VA (US)

(21) Appl. No.: 10/685,446

(22) Filed: Oct. 16, 2003

(51) Int. Cl. G06F 17/00; G06N 5/02; G06N 5/00; G06F 17/60

(52) U.S. Cl. 706/50; 705/1

(57) ABSTRACT

Systems and methods for evaluating a collaboration level among team members which allow team member to evaluate their collaboration level in a multiple choice format. The system receives team member collaboration level relevant choice selections or answers from team members in response to predetermined, and revisable relevant choices, generates advice to individual team members, and generates a team view of the state of team member collaboration based on a collection of choice selections or answers from two or more team members. A knowledge database is used in generating the team member advice and team view.

This invention was made with government support under contract number N00014-01-C-0317 awarded by Small Business Innovative Research (SBIR) through the U.S. Navy. The government has certain rights in the invention.

### BACKGROUND OF THE INVENTION

1. Field of Invention

This invention relates to systems and methods for evaluating, managing, and improving the level of collaboration among members of a team.

2. Description of Related Art

Teamwork is a part of our daily lives. For example, in a corporate environment, one needs to work with coworkers, subordinates and supervisors. In an international antiterrorism campaign, different countries need to work together as a team.

However, achieving effective collaboration of team members can be challenging. For example, in the event of 1962 Bay of Pigs, a talented and intelligent policy team was doomed to an unworkable plan with disastrous results. In the event of the 1988 Iranian airline shoot-down, a well trained team, due to misunderstanding of each other's information and perspectives, led to a tragic mistake.

### SUMMARY OF THE INVENTION

Effective team work needs knowledge-centered collaboration. Team members need collaboration knowledge to interact effectively for the benefit of the team. With knowledge-centered collaboration, team members can diagnose problems at early stages, as well as solve actual and potential problems after the problems have developed.

The systems and methods of this invention allow team members to be alerted to problems.

The systems and methods of this invention allow team members to obtain advice on or solutions to team member collaboration problems.

The systems and methods of this invention allow team members to be warned of consequences of collaboration problems.

The systems and methods of this invention allow team members to identify agreement and disagreement among team members.

The systems and methods of this invention help to identify risks which can impede successful team member collaboration issues and/or problems.

The systems and methods of this invention allow team members to understand possible causes of misunderstanding among team members.

The systems and methods of this invention allow team members to better coordinate their actions.

The systems and methods of this invention allow team members to self-educate with team collaboration awareness.

The systems and methods of this invention allow team members to track improvement, or lack thereof, in team member collaboration.

The systems and methods of this invention allow team members to assess the effects of changes in levels of collaboration of team work after introduction of new tools, processes and/or reorganizations.

The systems and methods of this invention allow team members to efficiently and effectively educate team members with respect to factors that may improve team member collaboration.

The systems and methods of this invention allow team members to evaluate the team member collaboration level with a knowledge database.

In various exemplary embodiments of systems and methods according to this invention, a team member evaluates team member collaboration level by being presented with a plurality of information concerning team collaboration areas of concern and associated issues related to those areas of concerns including, for example, causes of concern, problems associated with the areas of concern, reducers of problems associated with the areas of concern, warning signs associated with the areas of concern and with the causes of concern, risks associated with the problems, possible solutions to and/or corrective actions for the problems, risks associated with implementing the solutions and/or corrective actions. The systems and methods of the invention accomplish this presentation using a knowledge database which sets an evaluation value for each of the team collaboration areas of concern. The team member/user receives collaboration advice generated based on the analysis and is able to interact with the information presented to the user by, for example, indicating portions of the presented information with which the team member/user agrees or disagrees.

In various exemplary embodiments of systems and methods according to this invention, team members evaluate a team member collaboration level by selecting presented information items directed to collaboration issues and areas of concern. The selections from each team member are collected and analyzed using a knowledge database which sets an evaluation value for each area of concern and related issues. The team members are provided with a team view of the team's level of collaboration which is generated based on an analysis of the selections from the team members.

In various exemplary embodiments of systems and methods according to this invention, the knowledge database comprises the plurality of collaboration areas of concern. In various exemplary embodiments, the knowledge database includes information regarding 1) goal understanding, such as knowing what a customer/user/team member wants or what the goal of a mission is; 2) understanding of team member roles, tasks and schedule, such as, for example, knowing who is supposed to do what and when, and with what information and resources; 3) understanding of team member relationships and dependencies, such as, for example, knowing how entities, events and tasks impact an overall plan; 4) understanding characteristics and aspects of other team members, such as, for example, knowing what other team members' backgrounds, capabilities and preferences are; 5) understanding of team “business rules,” such as effective and/or agreed upon rules for team members to interact with each other; 6) team member task skills, such as knowing how to do one's assigned work; 7) team and team member activity awareness, such as, for example, knowing what others are doing now and current needs for doing it; 8) understanding of external situation, such as knowing status of people, things and events of the world outside the team and projecting future changes therein; 9) current task assessment and management, such as keeping tasks on track, knowing how well own and others' tasks are progressing, and when to offer help; 10) mutual understanding, such as knowing what other team members understand now and knowing if they agree or disagree with a given team member's understanding; 11) plan assessment, including, for example, predicting whether a plan will still enable the team to achieve its goals, knowing inter-task projections, and/or knowing plan prospects and danger points; 12) understanding of decision drivers, such as judging and applying criteria for selecting an action, ascertaining those criteria, deadlines for decisions to be made, uncertainty, and which team members and/or non-team members to involve, and 13) causes of low team member motivation, including low motivation from poor team performance, from different viewpoints of how the team should function, and from personal relationships.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of the systems and methods of this invention will be described in detail, with reference to the following figures, wherein:

FIGS. 1 and 2 are a flowchart outlining one exemplary embodiment of a method for evaluating a collaboration level according to this invention;

FIG. 3 illustrates a first exemplary embodiment of a user interface according to this invention;

FIG. 4 illustrates a second exemplary embodiment of a user interface according to this invention;

FIG. 5 illustrates a third exemplary embodiment of a user interface according to this invention;

FIG. 6 illustrates a fourth exemplary embodiment of a user interface according to this invention;

FIG. 7 illustrates a fifth exemplary embodiment of a user interface according to this invention;

FIG. 8 illustrates a sixth exemplary embodiment of a user interface according to this invention;

FIG. 9 illustrates a seventh exemplary embodiment of a user interface according to this invention;

FIG. 10 illustrates an eighth exemplary embodiment of a user interface according to this invention;

FIG. 11 illustrates a ninth exemplary embodiment of a user interface according to this invention;

FIG. 12 illustrates the tenth exemplary embodiment of a user interface according to this invention;

FIG. 13 illustrates an eleventh exemplary embodiment of a user interface according to this invention;

FIG. 14 illustrates a twelfth exemplary embodiment of a user interface according to this invention;

FIG. 15 illustrates a thirteenth exemplary embodiment of a user interface according to this invention;

FIG. 16 illustrates a fourteenth exemplary embodiment of a user interface according to this invention;

FIG. 17 illustrates a fifteenth exemplary embodiment of a user interface according to this invention; and

FIG. 18 is a functional block diagram of one exemplary embodiment of a collaboration level evaluating system according to this invention.

### DETAILED DESCRIPTION OF EXEMPLARY EMBODIMENTS

In various exemplary embodiments of the systems and methods according to this invention, a collaboration level among team members is evaluated. In various exemplary embodiments, an evaluation begins based on selections from a single member or user in response to a plurality of relevant topics and issues related to those topics, using a knowledge database. Advice is generated for this single user based on the evaluation. In various other exemplary embodiments, the evaluation is based on selections from a plurality of members in response to a plurality of topics and issues related to those topics, using a knowledge database. A team view may be generated based on the evaluation. When users use the tool, they may specify whether their team is just forming or whether it is now executing its tasks. Further, they may specify whether they have previously used the tool for this team. The tool will then tailor its behavior for these different contexts.

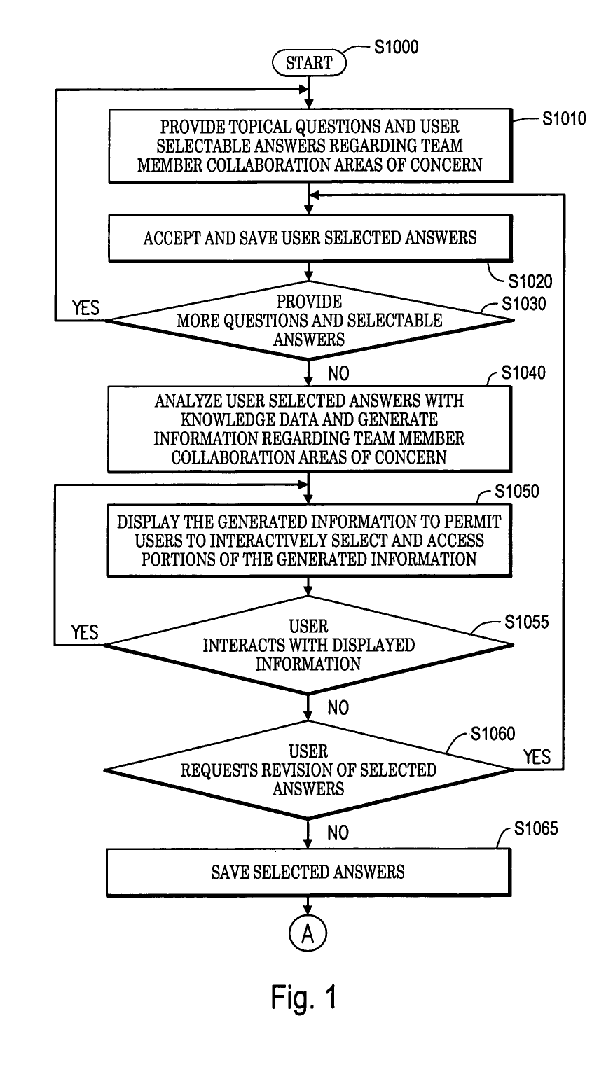

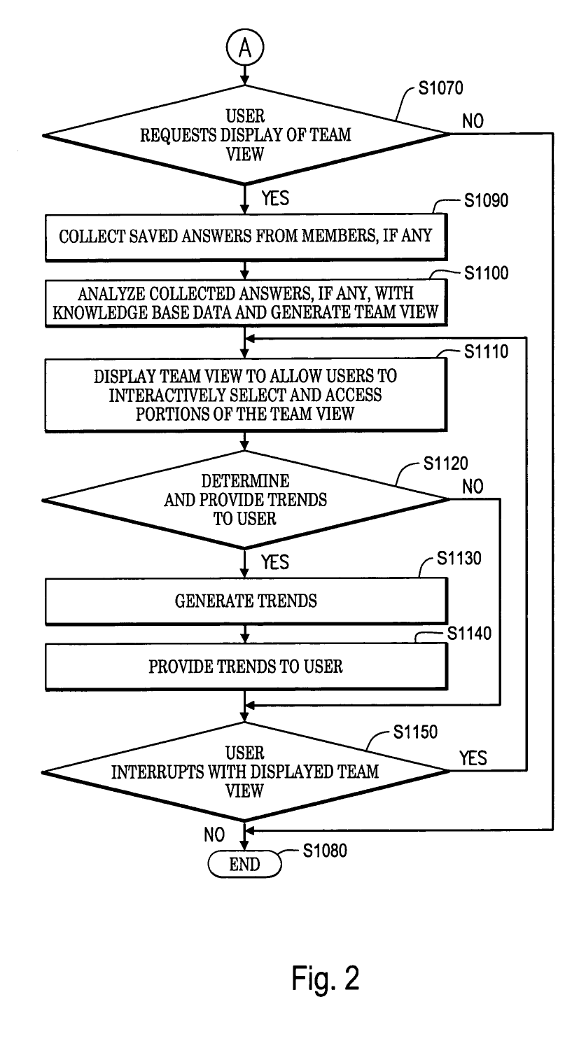

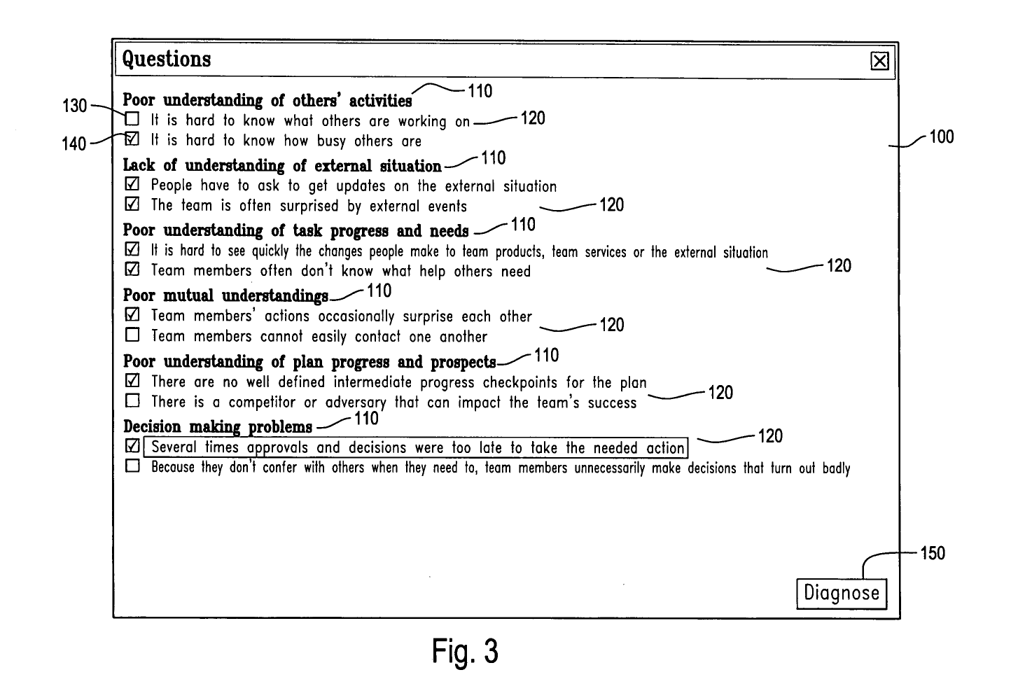

FIGS. 1 and 2 are a flowchart outlining one exemplary embodiment of a method for evaluating a collaboration level. Beginning in step S1000, operation of the method continues to step S1010, where topics and issues relevant to areas of concern to team member collaboration are displayed. As will be discussed in greater detail below in connection with FIG. 3, each question is associated with a topic or aspect of concern, e.g., is relevant, to team collaboration. Associated with each topic and/or related issues are one or more possible selections that represent aspects, facets and/or characteristics of each topic and/or issue that can be agreed with or disagreed with, e.g., by placing a check mark beside each possible selection.

Then, in step S1020, selections are received from a member or a user and saved. In various exemplary embodiments, the selections to a team collaboration topic and/or issue may be made from one or more predetermined presented possibilities. The predetermined selections contain information relevant to a particular team collaboration relevant topic and/or issue. As will be discussed in greater detail below, in various exemplary embodiments, the device used for receiving selections from a user, such as, for example, a team member, may be different from the device for displaying the selections. In various other exemplary embodiments, the device for receiving selections may be the same device used for displaying selections.

Next, in step S1030, a determination is made whether to provide more questions and selectable answers. In various exemplary embodiments, additional team collaboration relevant topics and/or issues may be addressed, each topic and/or issue being covered by one or more selections. Further predetermined selections may also be provided based on the received selections, such that the additional selections may be displayed for obtaining additional selections. The additional are provided based on received answers that indicate that the topic under consideration may need to be further explored. The system may generate the additional selections on its own and/or additional selections may be made by a user from a list of possible selections provided by the system.

If it is determined that more selections are to be provided, operation of the method jumps back to step S1010, where new topical and/or related issue selections are provided to the user to make appropriate selection(s).

Otherwise, if it is determined unnecessary to provide more selections, control proceeds directly to step 1040, where the topical selections made are analyzed using knowledge data. As will be discussed in greater detail below, the knowledge data contains expert information on team collaboration and is capable of being updated. The topical selection alternatives may be ranked based on their relevance to team collaboration. The ranking of the selections made may be based on various relevance criteria, including the apparent relative importance given to each particular topical selection alternative by the user. For example, selections made with respect to the twelve team member collaboration relevant topics listed in paragraph [0020], above, may be ranked based on the relevance attached to each topic by all users, or the extent to which all users selections indicate an understanding of each topic, or the extent to which all users agree on a proposed selection with respect to a particular topic, or the extent to which all users' selections made indicate agreement with the first listed proposed selection for each topic specified by the knowledge base, or the extent to which all users selections made express disagreement with suggested selections by the knowledge base with respect to the topics, etc. Control then proceeds to step S1050.

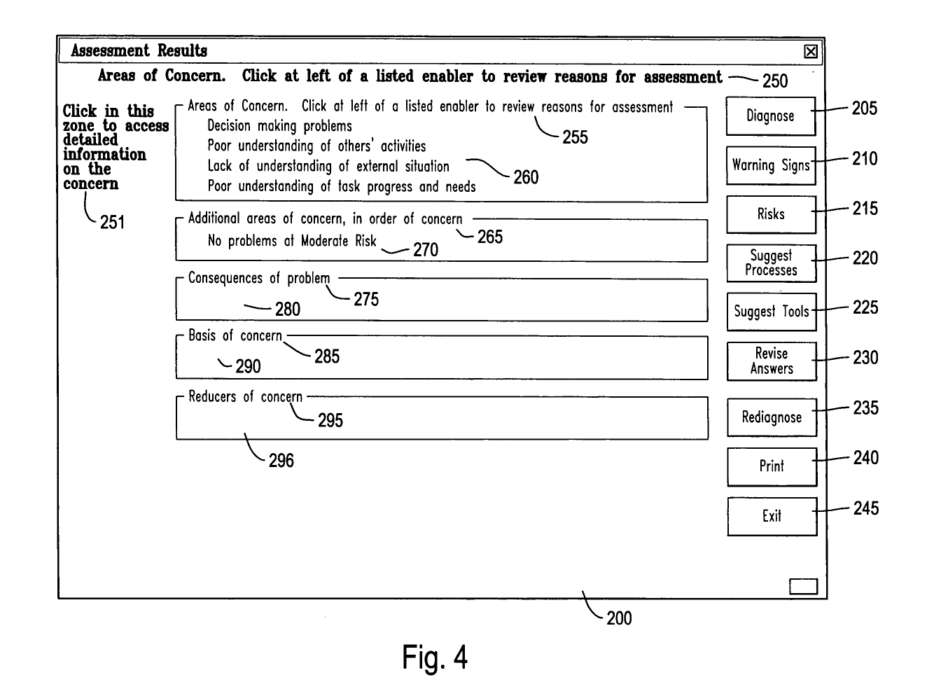

In step S1050, a listing of the ranked topical selections is displayed or otherwise provided to a user. This is discussed in greater detail below in connection with FIG. 4, which shows the ranked areas of concern in the top two boxes, 255 and 265.

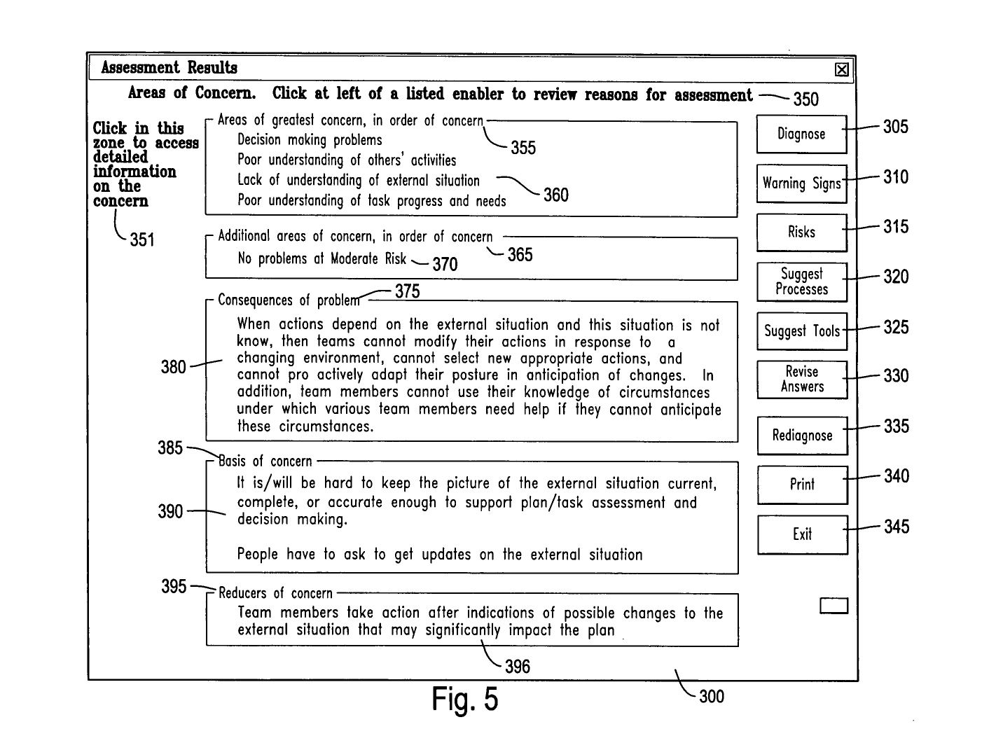

In various exemplary embodiments of the systems and methods of the invention, the display is organized with different levels or screens such that the user can interact with the display device to review different levels of evaluation regarding different aspects of the team collaboration analysis according to the user's needs. As will be discussed in greater detail in connection with FIGS. 4 and 5, the display initially displays analysis results regarding the diagnosis of the selections made. The user is permitted to interact with the displays to review different aspects of the diagnosis. It should be appreciated that the display may also initiate with other analysis results, such as warning signs and risk assessment, as discussed below. Operation of the method then proceeds to step S1055.

In step S1055, a determination is made whether the user interacts with the displayed information. If it is determined that the user interacts with the displayed information, control returns to step S1050, where additional information requested by the user is displayed. Otherwise, if it is determined that the user does not interact with the displayed information, control continues to step S1060.

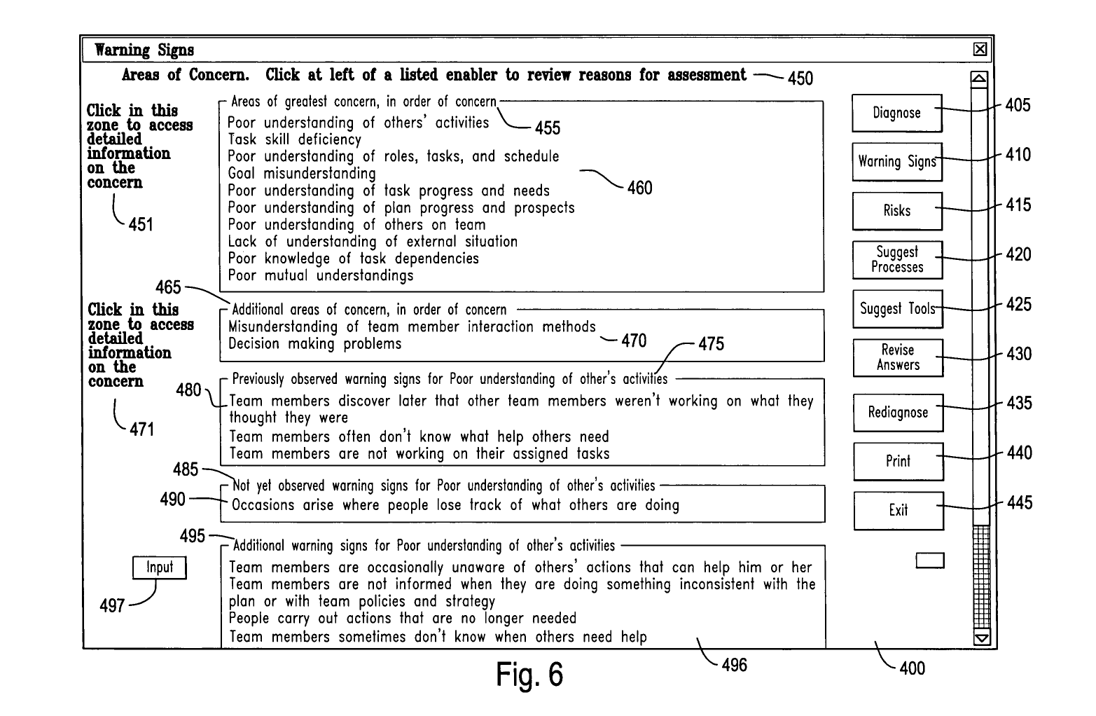

As will be discussed in greater detail in connection with FIGS. 6-8, the user may interact with the displayed information to select that the analysis results regarding warning signs to be displayed. Such a display provides a listing of warning signs to the user of possible problems affecting team members that may arise and/or be expected to be associated with the concerns addressed by the topical selections provided to a user. The user may interact with the display to review and/or update the aspects associated with the warning signs.

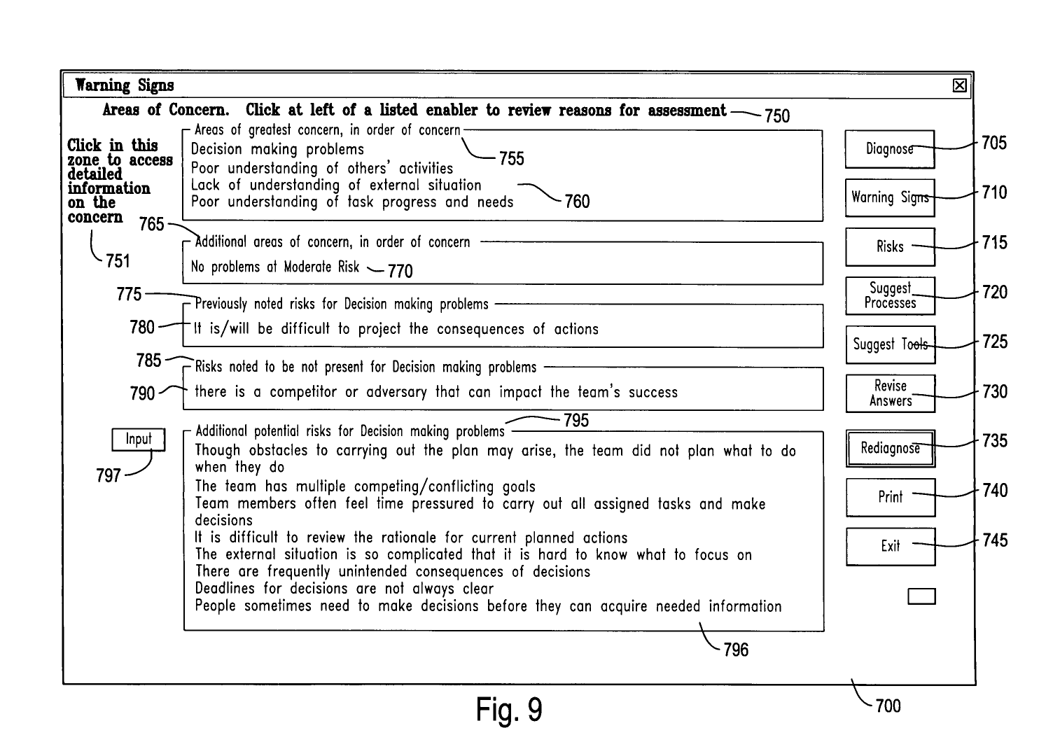

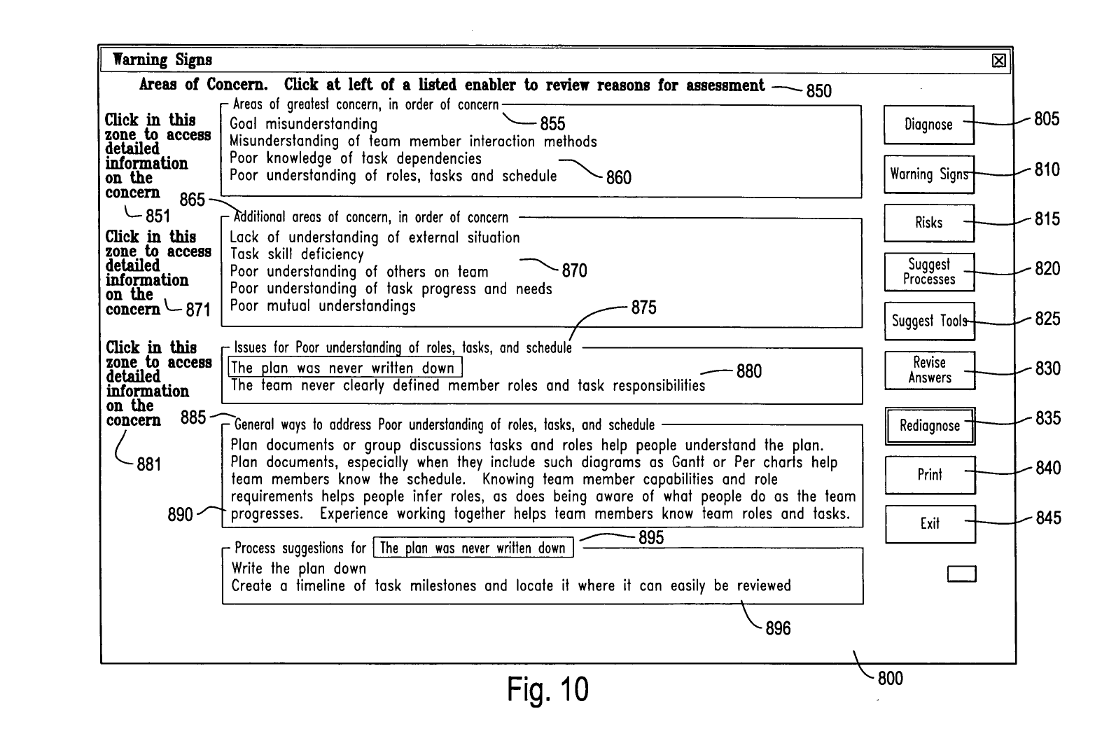

As will be discussed in greater detail in connection with FIGS. 9 and 10, the user may select that the analysis results regarding risk assessment and/or suggested actions to be displayed. The user may interact with the display to review different aspects associated with the risk assessment and/or suggested actions.

Next, in step S1060, a determination is made whether the user requests revision of one or more selections made by the user. As discussed in greater detail below, such revision is useful for obtaining analysis results for what-if scenarios, such as for the purposes of self-education.

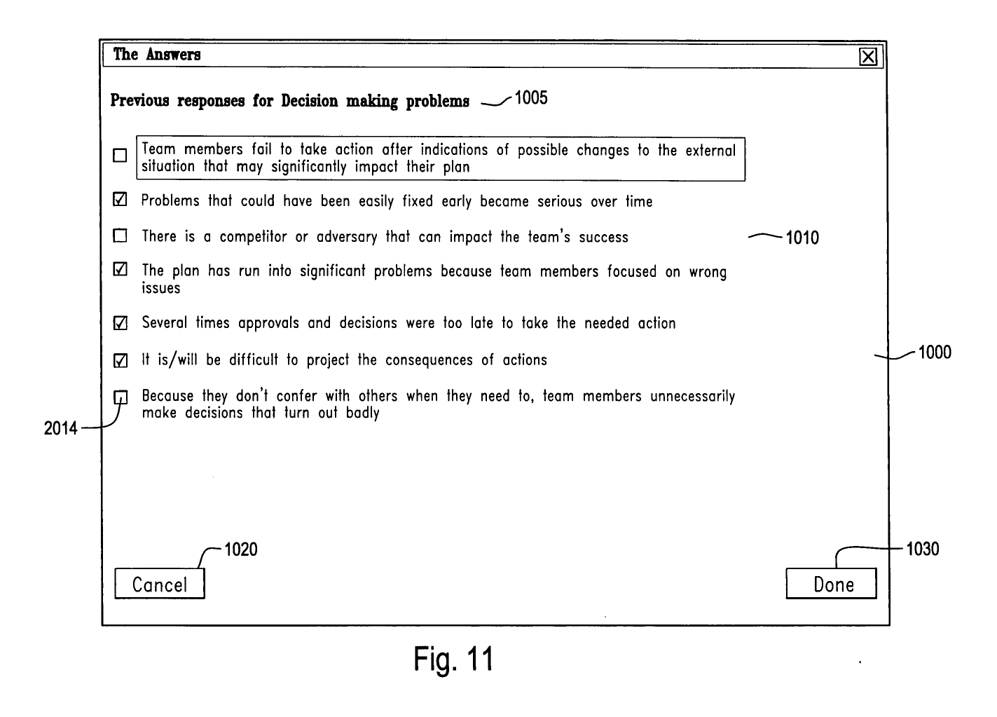

If it is determined in step S1060 that the user requests such a revision, operation of the method jumps back to step S1020, where revised selections made are accepted and saved. As will be discussed in greater detail in connection with FIG. 11, the user is allowed to revise the answers to questions in a specific topical area. On the other hand, if it is determined that no revision is necessary, operation of the method proceeds to step S1065, where the non-revised selected choices are saved. This saving is in addition to any saving performed in step S1020.

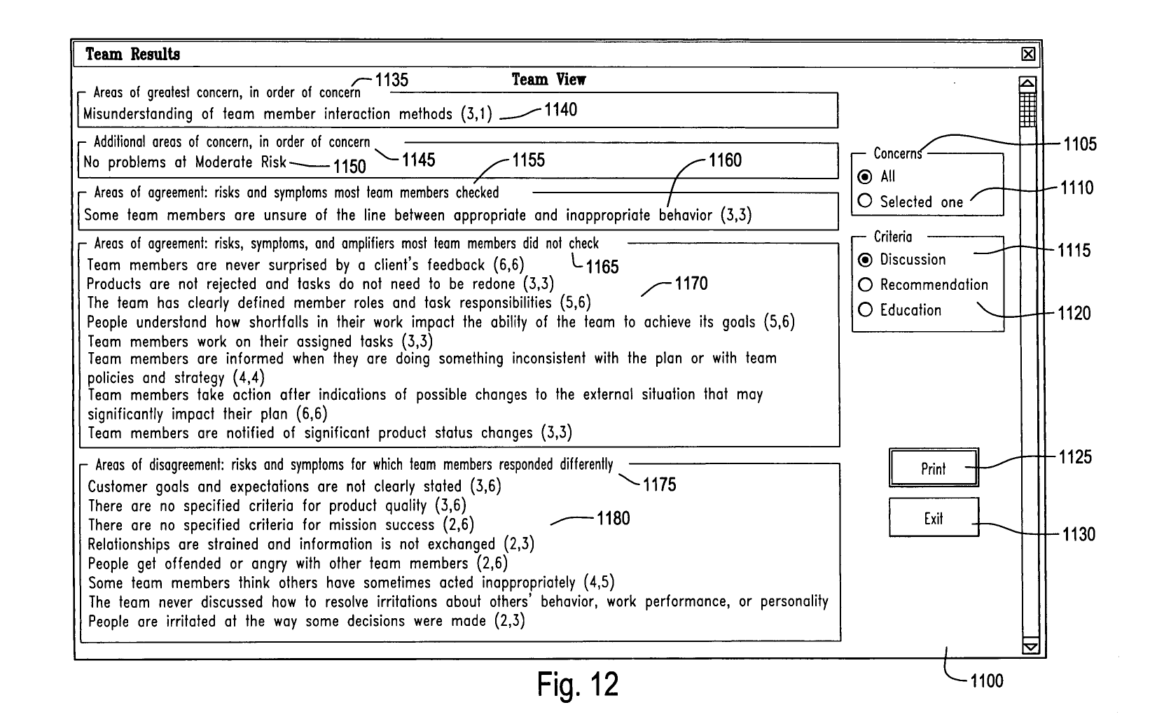

Next, in step S1070, a determination is made whether to display a team view of the results of the topical questions relevant to team members' collaboration areas of concern. As discussed in greater detail below in connection with FIGS. 12-17, the team view is generated based on saved selected choices (or answers) from a plurality of team members, and indicates areas of agreement among team members and areas of disagreement among team members, along with proposed suggestions of actions to take and/or tools to use to reduce areas of disagreement and/or increase areas of agreement.

If it is determined, in step S1070, that the team view is to be displayed, such as, for example, if this is not the first team member user, operation of the method continues to step S1090, where saved answers from team members are colleted. Then, in step S1100, the collected answers are analyzed with knowledge data to generate the team view. Next, in step S1110, the team view is displayed. Then control proceeds to step S1120 where a determination is made whether to determine and provide, e.g., display, to a user, team member trends. If so, control proceeds to step S1130, where the trends are determined and then to step Si 140 where the trend analysis is presented, e.g., displayed, to a user, and control proceeds to step S1150. If a decision is made not to proceed to determine and display trend(s), control proceeds directly to step S1150, and the user is allowed to select and access portions and/or aspects of the team view based on the user's needs. Exemplary embodiments of the display are shown, for example, in FIGS. 12-17.

In step S1150, a determination is made whether the user interacts with the displayed team view. If it is determined that the user interacts with the displayed team view, control returns to step S1111, where additional aspects of the team view, as requested by the user, are displayed. Otherwise, if it is determined that the user does not interact with the displayed team view, operation of the method proceeds to step S1080, where the process ends.

On the other hand, if it is determined in step S1070 that it is not necessary to display the team view, operation of the method directly jumps to step S1080, where operation of the method ends.

It should be appreciated that steps S1070, S1090, S1100, S1110 through S1150 may be omitted, so that the method illustrated in FIGS. 1 and 2 may be used for a user to obtain analysis results based only on that user's answers. It should also be appreciated that steps S1070, S1090, S1100, S1110 through S1150 may be practiced alone, without the other steps, so that a user may obtain the team view based on saved answers of various team members.

FIG. 3 illustrates a first exemplary embodiment of a user interface according to this invention. As shown in FIG. 3, the graphical user interface 100 comprises a list of issues/topics 1 10. Each of the issues/topics pertains to a particular topic or aspect which is relevant to team member collaboration, and is followed by one or more predetermined alternatives for selection by a user. The predetermined selectable choices contain collaboration level information. Each selectable choice is preceded with a selection indicator 130. When a user selects a choice, a check sign 140 is placed in the selection indicator 130 of the selected choice.

A user may select more than one choice to the same issue/topic, if the user determines that more than one choice is applicable. Alternatively, a user can leave unselected all predetermined choices to an issue/topic, if the user determines that none of the predetermined choices apply, or is particularly relevant, to the corresponding issue/topic.

As shown in FIG. 3, the graphical user interface 100 has a “Diagnose” button 150. When a user finishes entering making selections via the graphical user interface 100, the user can activate the diagnose button 150 to proceed further into the collaboration evaluation process. In various exemplary embodiments, the number of selectable choices may range from about 30 to about 50, but may be larger or smaller.

In various exemplary embodiments, the answers are evaluated to determine whether to ask more topical questions. If so, the activation of a “Continue” button (not shown) will lead to more questions displayed on the same or a subsequent screen or page of the graphical user interface 100.

As shown in FIG. 3, the questions are related to team collaboration. A user becomes aware of the questions, during the answering process, even if the user has not thought about these questions. Thus, the user can be educated on team collaboration topics of concern by simply reviewing the questions.

In the exemplary embodiment shown in FIG. 3, answers to questions may be directly selected on the same interface where the questions are displayed. In various other exemplary embodiments, the answers to the questions may be selected through a device different from the interface provided with the display.

FIG. 4 illustrates a second exemplary embodiment of a user interface display according to this invention. This user interface may be displayed after the activation of the diagnose button 150 in FIG. 3 and after all questions have been displayed and appropriate answers selected.

As shown in FIG. 4, the user interface 200 comprises a “Diagnose” button 205, a “Warning Signs” button, a “Risk” button (or “Risk Assessment” button) 215, a “Suggest Processes” button 220, and a “Suggest Tools” button 225. As will be discussed in greater detail below, the “Diagnose” button 205, if activated, will enable a display of the ranked questions and answers discussed above regarding step S1050. The answers to the ranked questions may indicate team member collaboration problem areas. The warning signs button 210, if activated, will enable a display of observable behaviors or team member statements that may be used to confirm concerns of diagnosed team performance problems. The risk button 115, if activated, will enable a display of the environmental, team, or task factors that can impede successful collaboration. The suggest processes button 220, if activated, will enable the display of suggestions for addressing the concerns. The suggest tools button 225, if activated, will enable the display of suggested tools for addressing the concerns, including, for example, for improving team collaboration, such as updated equipments for improved communication and/or the association with another firm/corporation for more expertise.

As shown in FIG. 4, the graphic user interface 200 further comprises a “Revise Answers” button 230 and a re-diagnose button 235. As will be discussed in greater detail below, the “Revise Answers” button 230, if activated, will enable a user to revise the answers the user entered in response to the displayed questions. The “Re-diagnose” button 235, if activated, will enable updating of the evaluation based on the revised answers.

The graphic user interface 200 also comprises a “Print” button 240 and an “Exit” button 245. A user can select the “Print” button 240 to print a copy of the graphic user interface 200. The user can select the “Exit” button 245 to exit the evaluation process.

The exemplary embodiment of the graphic user interface 200 shown in FIG. 4 further comprises a title 250, a first portion 255, a second portion 265, a third portion 275, a fourth portion 285 and a fifth portion 295. Each of the first through fifth portions 255-295 address concerns related to the received answers. In various exemplary embodiments, the graphical user interface 200 may comprise other portions to address other concerns related to the team member collaboration topics and/or aspects, including received answers.

The first portion 255 comprises a list of concerns 260. The concerns 260 are listed in the order of the importance of the concerns. The first portion further comprises an instruction 251, which instructs a user to select a concern listed in the list of concerns 260 so as to enable an interactive display regarding the selected concern, as discussed in greater detail below.

The second portion 265 comprises a list of additional concerns 270, if any. The additional concerns 270 are listed in the order of the importance of the additional concerns. In various exemplary embodiments, the additional concerns 270 may have a different, e.g., lower, degree of importance than the concerns 260 listed in the first portion 255.

In the exemplary embodiment shown in FIG. 4, based on a set of selected answers, the list of concerns 260 contained in the first portion 255 comprises four concerns: decision making problems, poor understanding of others' activities, lack of understanding of external situation, and poor understanding of task progress and needs. Based on this set of answers, there is no additional concern 270 listed in the second portion 265.

In various exemplary embodiments, the first and second portions 255 and 265, listing concerns based on a set of answers/selected choices, may remain displayed in the graphic user interface regardless whether the diagnose button 205, the warning signs 210, the risk button 215 or the suggest processes button 220 is activated. In various exemplary embodiments, the contents of the third, the fourth and the fifth portions 275, 285 and 295, respectively, may be displayed separately depending on, for example, whether the “Diagnose” button 205, the “Warning Signs” button 210, the “Risks” button 215, the “Suggest Processes” button 220 or the “Suggest Tools” button 225 is/are activated.

In the exemplary embodiment shown in FIG. 4, the contents of the third, the fourth and the fifth portions 275, 285 and 295, respectively, are displayed when the diagnose button 205 is activated. As shown in FIG. 4, under the activation of the diagnose button 205, the third portion 275 comprises a field 280 to list consequences of problems. The consequences of a problem are in response to, and will be displayed after a selection of, a concern listed in the first portion 255 or the second portion 265. The selection of a concern is achieved based on the instruction 251 by, for example, clicking on the concern. The consequences listed in the field 280 address the potential consequences of team member knowledge deficiency.

The fourth portion 285, which represents the situation when the “Diagnose” button 205 is activated, comprises a field 290 to list basis of concern in response to a concern selected from the first portion 255 or the second portion 265. The basis of concern provides a rationale why there is such a concern, as will be discussed in greater detail below.

The fifth portion 295, when the diagnose button 205 is activated, comprises a field 296 to list possible methods and/or tools to reduce concern (s) selected from the first portion 255 or the second portion 265.

FIG. 5 illustrates a third exemplary embodiment of a user interface according to this invention. As shown in FIG. 5, the graphical user interface 300 is similar to the graphical user interface 200 shown in FIG. 4 in that the buttons 305-345 of FIG. 4 correspond to the buttons 205-245 of FIG. 3 and that the portions 350-395 of FIG. 4 correspond to portions 250-295. Differences between the graphical user interface 300 in FIG. 5 and the graphical user interface 200 in FIG. 4 include the fact that, in FIG. 5, the concern “lack of understanding of external situation” is selected from the first portion 355, and that information corresponding to this selected concern is displayed in the third portion 375, the fourth portion 385 and the fifth portion 395. In the exemplary embodiment shown in FIG. 5, for example, the consequences of the selected concern is shown in the field 380, the basis of the concern is shown in the field 390, and the reducers of the concern is shown in the field 396.

FIG. 6 illustrates a fourth exemplary embodiment of a user interface according to this invention. The graphical user interface 400 in FIG. 6 is similar to the graphical user interface 300 in FIG. 5 in that the buttons 405-445 of FIG. 5 correspond to the buttons 305-345 of FIG. 4. The first portion 455 and the second portion 465 of FIG. 6 correspond to the first and second portions 355 and 365, respectively, in FIG. 5. However, the graphical user interface 400 of FIG. 6 displays information in response to a set of answers that is different from the answers to which the information displayed in the graphical user interface 300 of FIG. 5 responded. Thus, the number and contents of the concerns listed in the first and second portions differ. In particular, the first portion 455 lists ten concerns in the field 460. Also, the second portion 465 lists two additional concerns in the field 470. As shown in FIG. 6, when there are one or more additional concerns listed in the second portion 465, an instruction 471 is displayed to instruct a user to select one of the additional concerns to possibly interactively enable more display associated with the selected additional concern.

The graphical user interface 400 in FIG. 6 is different from the graphical user interface 300 in FIG. 5 in that the graphical user interface 400 is generated when the warning sign button 410 (310) is activated. Thus, in FIG. 6, the third portion 475, the fourth portion 485 and the fifth portion 495 are displayed in response to the activation of the warning sign button 410. In particular, the third portion 475 displays previously observed warning signs, the fourth portion 485 displays warning signs not yet perceived, and the fifth portion 495 displays additional warning signs not yet asked for or about.

The graphical user interface 400 of FIG. 6 is generated when the concern “poor understanding of others activities” is selected in the first portion 455. Accordingly, the field 480, the field 490 and the field 496 display information related to the previously observed but not yet perceived, asked for or asked about warning signs, and additional warning signs for “poor understanding of others activities.” In various exemplary embodiments, the previously observed warning signs may be the warning signs already seen, the not yet observed warning signs are the warning signs the user indicates that have not been seen, and the additional warning signs are the warning signs which the user has not been provided.

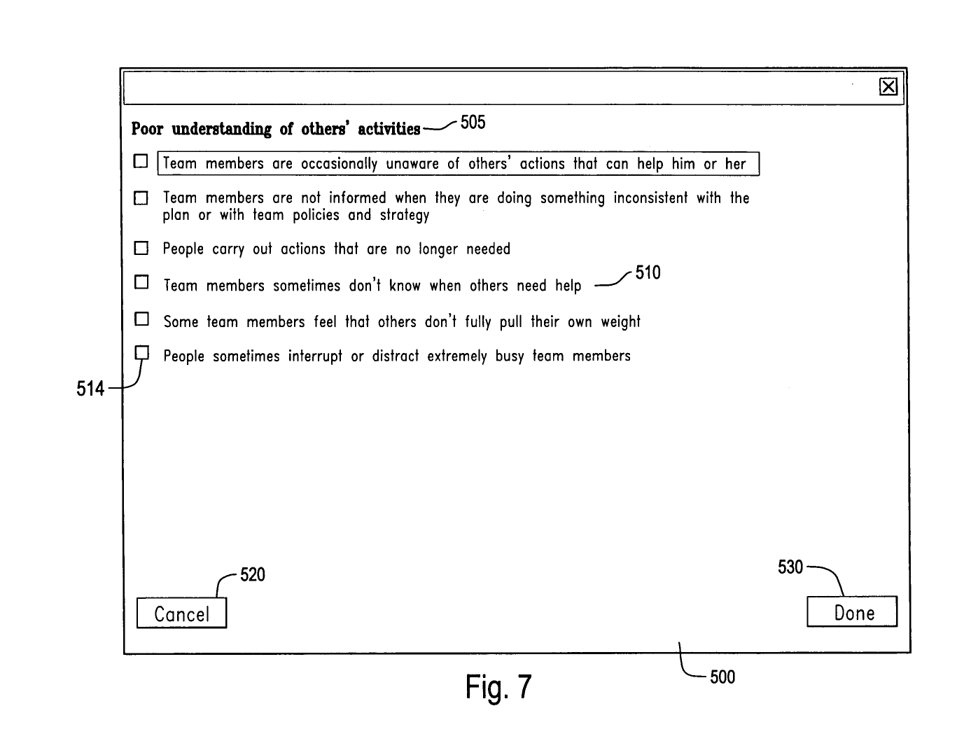

As shown in FIG. 6, the graphical user interface 400 further comprises an “Input” button 497, which allows the user to update the additional warning signs listed in the fifth portion 495, as discussed below in connection with FIG. 7.

FIG. 7 illustrates a fifth exemplary embodiment of a user interface according to this invention. The graphical user interface 500 may be displayed in response to the activation of the “Input” button 497 in FIG. 6 to, for example, update the list of additional warning signs listed in the fifth portion 496.

As shown in FIG. 7, the graphical user interface 500 comprises a title 505 which corresponds to the concern “poor understanding others' activities” selected from the first portion 455 of FIG. 6. The graphical user interface 500 further displays a list 510 that corresponds to the list of additional warning signs listed in the fifth portion 495 of FIG. 6. Each item in the list 510 is preceded with a selection indicator 514. When a user wishes to correct the list of the additional warning signs by specifying an item in the list 510 that the user has already seen, the user may select this item by placing a check sign in the selection indicator 514 preceding this item.

As shown in FIG. 7, the graphical user interface 500 further comprises a “Cancel” button 520 and a “Done” button 530. The cancel button 520 may be enabled by the user to cancel updating of the additional warning signs. The done button 530 may be selected to enable the updating of the additional warning signs listed in the fifth portion 495 in FIG. 6 by removing the items listed in the field 496 that correspond to the items selected in the list 510 in FIG. 7. In various exemplary embodiments, the information displayed when the diagnose button 405 is activated may also be updated after the “Re-diagnose” button 435 is activated based, for example, on the information entered on the graphical user interface 500 of FIG. 7.

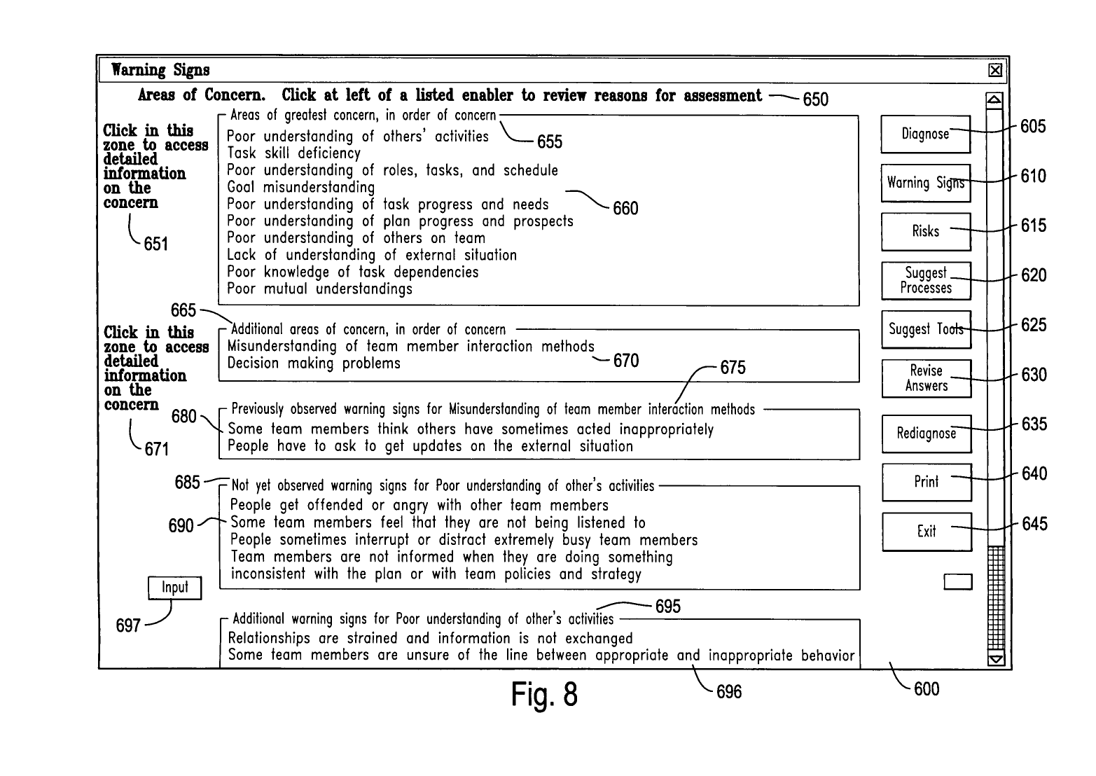

FIG. 8 illustrates a sixth exemplary embodiment of a user interface according to this invention. The graphical user interface 600 is identical to the graphical user interface 400 in FIG. 6 except that, in FIG. 8, the concern “misunderstanding of team member interaction methods” listed in the second portion 665 is selected. (In FIG. 6, the concern “poor understanding of others' activities” was displayed.) Accordingly, the third portion 675, the fourth portion 685 and the fifth portion 695 display the previously observed warning signs, the not-yet observed warning signs and additional warning signs, respectively, for the selected concern “misunderstanding of team member interaction methods.”

FIG. 9 illustrates a seventh exemplary embodiment of a user interface according to this invention. The graphical user interface 700 in FIG. 9 is similar to the graphical user interface 300 in FIG. 5 except that, in FIG. 9, the graphical user interface 700 is displayed when the “Risks” button 715 (315) is activated. Accordingly, the third portion 775, the fourth portion 785 and the fifth portion 795 display information related to risks. In particular, the third portion 775, the fourth portion 785 and the fifth portion 795 display information related to previously noted risks, risks noted to be not present and additional potential risks not previously asked about, respectively.

In FIG. 9, the concern “decision making problems” is shown as being selected in the first portion 775. In response, the third portion 775, the fourth portion 785 and the fifth portion 795 may display previously noted risks, risks noted to be not present and additional potential risks, respectively, for the selective concern “decision making problems.”

As shown in FIG. 9, the graphical user interface 700 further comprises an “Input” button 797 which, similar to the “Input” button 697 in FIG. 8, enables a user to update the additional potential risks listed in the fifth portion 795.

FIG. 10 illustrates an eighth exemplary embodiment of a user interface according to this invention. The graphical user interface 800 in FIG. 10 is similar to the graphical user interface 300 in FIG. 5, except that, in FIG. 10, the graphical user interface 800 may be displayed when the suggest processes 820 (320) is activated. Accordingly, the third portion 875, the fourth portion 885, and a fifth portion 895 of the graphical user interface 800 displays information related to suggestions for addressing the concerns listed in the first portion 855.

In the exemplary embodiment shown in FIG. 10, the concern “poor understanding of roles, tasks and schedule” is shown as selected. In response, the third portion 875 comprises a list 880 of issues for poor understanding of roles, tasks and schedule. The third portion 875 further comprises an instruction 881 to instruct a user to select an issue listed in list 880 to enable the user to interactively obtain more information related to the selected issue listed in the list 880. FIG. 10 shows that the issue “the plan was never written down” is selected. Accordingly, the fifth portion 895 comprises a list of suggestions 896 related to the issue “the plan was never written down.” Also, the fourth portion 885 displays, in the field 890, general ways to address the concern of “poor understanding of roles, tasks and schedule.”

FIG. 11 illustrates a ninth exemplary embodiment of a user interface according to this image. The graphical user interface 1000 is displayed when the revise answers button 730 of FIG. 9, or other corresponding buttons, is activated to allow the user to change the answers related to the concern “decision making problems” selected from the first portion 755 of FIG. 9, which were entered when the user was responding to the questions displayed in FIG. 3 at the beginning of the evaluation process. As shown in FIG. 11 the graphical user interface 1000 comprises a title 1005 which identifies the previous responses for the concern “decision making problems” selected in the first portion 775 in FIG. 9. The graphical user interface 1000 further comprises a list 1010 of responses related to the concern “decision making problems.” These responses represent questions that have been displayed to and responded by the user. Each response is associated with a selection indicator 1014. The responses previously selected by the user are indicated with a check sign in the corresponding selection indicators, while the responses that were not selected by the user are not indicated by check signs.

The graphical user interface 1000 enables the user to update the user's responses to the questions related to the concern “decision making problems” by removing check signs from previously selected responses and/or adding check signs to responses that were not previously selected.

The graphical user interface 1000 further comprises a cancel button 1020 and a done button 1030. The cancel button 1020 enables the user to cancel the updating process. The done button 1030, when activated, allows the user to implement the updating process.

The information displayed in FIG. 9, especially the list of concerns in the first and second portions 755 and 765, respectively, will be updated after the user activates the revise answers button 730 in FIG. 9, and/or updates answers in the list 1010 in FIG. 11, and then activates the re-diagnose button 735 in FIG. 9. The combination of the “Revise Answers” button 730 and the “Re-diagnose” button 735 enables a user to explore “what if “scenarios so that a user can perform self education regarding topics and factors relevant to team member collaboration.

FIG. 12 illustrates a tenth exemplary embodiment of a user interface according to this invention. As shown in FIG. 12, the team view graphical user interface 1100 comprises a concerns selection portion 1105 and a criteria selection portion 1115. The concerns selection portion 1105 comprises two “Radio” buttons 1110, with the first “Radio” button for the selection of “all” and the second “Radio” button for “selected one.” When the first “Radio” button for “all” is selected, the team view displayed in the graphical user interface 1100 may be generated based on concerns over all team member collaboration knowledge areas. Alternatively, when the second “Radio” button for “selected one” is selected, the team view displayed in the graphical user interface 1100 may be generated based on concerns in one selected team member collaboration knowledge area..

The criteria selection portion 1115 comprises three “Radio” buttons 1120, associated with “discussion,” “recommendation” and “education,” respectively. In various exemplary embodiments, different evaluation values may be assigned to different questions so that the questions may be weighted differently when the answers to the questions are evaluated. In various exemplary embodiments, different evaluation values are assigned to a same question when this question is evaluated for different purposes, such as for discussion, recommendation and education regarding team collaboration.

When the “Radio” button of “discussion” is selected, the team view displayed in the graphical user interface 1100 may be generated based on a “discussion criteria.” Under the discussion criteria, each question displayed for members to answer may be given a unique discussion value or weight. Accordingly, answers to different topical questions may be weighted differently in the evaluation process based on the different discussion values of the topical questions. The information generated based on the discussion values of the topical questions is used for discussion and exploration of team collaboration issues. The discussion values of the topical questions affect the determination of the importance of concerns, and, as discussed in greater detail below, whether the concern regarding a particular topical question will be considered important enough to be listed, or listed at the top of a list, in the team view.

When the “Radio” button of the “recommendation” is selected, the team view may be generated based on recommendation values of the topical questions. The recommendation values of the topical questions are used in making recommendations in response to problems associated with the listed concerns. Alternatively, when the “Radio” button of “education” is selected, the team view may be generated based on the education values of the topical questions. The education values of the topical questions may be set based on the importance of each question for the purpose of educating team members concerning team member collaboration.

The graphical user interface 1100 may further comprise a “Print” button 1125 and an “Exit” button 1130. The “Print” button 1125 enables a user to print a copy of the team review displayed in the graphical user interface 1100. The “Exit” button 1130 allows the user to exit the evaluating process.

As shown in FIG. 12, the graphical user interface displays 1100 the team view in five portions 1135, 1145, 1155, 1165 and 1175. In various exemplary embodiments, the first portion 1135 comprises a list 1140 of knowledge areas of highest concern, taking into account how many team members agreed with statements when answering the questions. The second portion 1145, which may be of lesser concern than the first portion 1135, comprises a list 1150 of important knowledge areas for the team to pay attention to.

Each knowledge area listed in the first portion 1135 and the second portion 1145 is associated with two numbers in parentheses. In various exemplary embodiments, the first number is a number of team members from whom the knowledge area was noted as a significant concern. The second number is a number of team member from whom the knowledge area was noted as a moderate concern. As shown in FIG. 12, the knowledge area “misunderstanding of goals” listed in the first portion 1135 is associated with two numbers (3,1). This pair of numbers represents that the knowledge area “misunderstanding of goals” was noted as a significant concern by three members, a moderate concern by one member, and not listed as a concern by the rest of the members.

As shown in FIG. 12, the third portion 1155 comprises a list 1160 regarding areas of agreement where risks and areas of concern have been noted by most team members. The fourth portion 1165 comprises a list 1170 regarding areas of agreement where risks, areas of concern and amplified versions thereof for most team members did not agree. The fifth portion 1175 comprises a list 1180 regarding areas of disagreement where risks and areas of concern are noted differently by different team members.

The items listed in the third portion 1155, the fourth portion 1165 and the fifth portion 1175 are each associated with two numbers in parentheses. In various exemplary embodiments, the first number represents the number of team members who agreed with a particular item. The second number represents the number of team members who saw a particular item. As shown in FIG. 12, the item “team members are never surprised by a client's feedback” listed in the fourth portion 1165 is followed by two numbers (6,6). This pair of numbers represents that six team members saw the statement “team members are never surprised by a client's feedback” and all of the six members agreed with it.

The team view displayed in the graphical user interface 1100 in FIG. 12 may be generated with the “Radio” button of “all” in concerns selection portion 1105 and the “Radio” button of “discussion” in the criteria selection portion 1115 selected. Thus, the team view displayed in FIG. 12 may be generated with concerns over all knowledge areas and with questions weighted by their discussion values in the evaluation analysis.

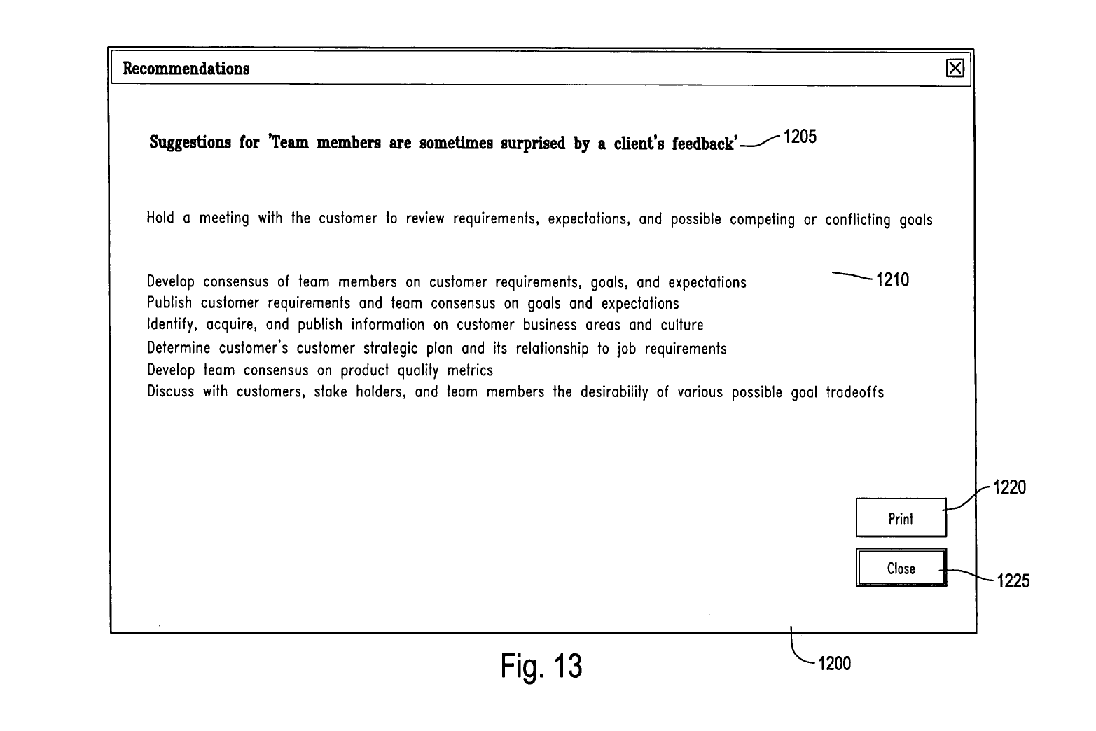

The items listed in the third portion 1155, the fourth portion 1165 and the fifth portion 1175 in FIG. 12, when selected by a user, will cause a new interface to be created. The new interface displays recommendations for solving the problems associated with the selected item, as discussed below in connection with FIG. 13 when “Recommendation” is selected.

FIG. 13 illustrates an eleventh exemplary embodiment of a user interface according to this invention. The graphical user interface 1200 in FIG. 13 is created when the item “team members are never surprised by a client's feedback” listed in the fourth portion 1165 in FIG. 12. As shown in FIG. 13, the graphical user interface 1200 comprises a title 1205 to identify which item serves as the basis to generate this interface. The graphical user interface 1200 further comprises a list of recommendations 1210 for solving the problems associated with the selected item. The graphical user interface further comprises a “Print” button 1220 and a “Close” button 1225 which enable the user to print and close, respectively, the graphical user interface 1200.

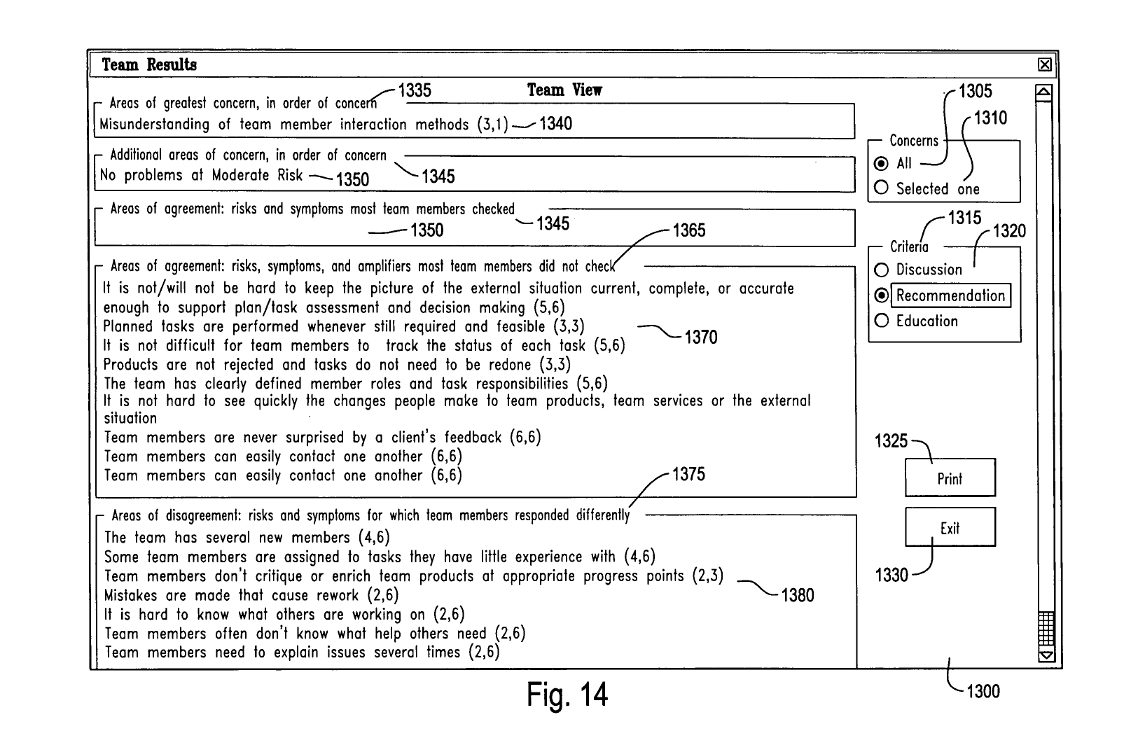

FIG. 14 illustrates a twelfth exemplary embodiment of a user interface according to this invention. The graphical user interface 1300 is generally identical to the graphical user interface 1100 in FIG. 12 except that, in FIG. 14, the graphical user interface 1300 displays the team view generated based on the recommendation values of the questions, as indicated in the criteria selection portion 1315 (1115) where the “Radio” button of “recommendation” is checked. Accordingly, the items listed in the third portion 1355, the fourth portion 1365 and the fifth portion 1375 of FIG. 14 are different from the corresponding portions in the graphical user interface 1100 in FIG. 12. For example, the item “team members are never surprised by a client's feedback” listed at the top of the fourth portion 1165 in FIG. 12 is now listed near the bottom of the fourth portion 1365 in FIG. 14. Nevertheless, the contents of the first portion 1335 and the second portion 1345 remain unchanged.

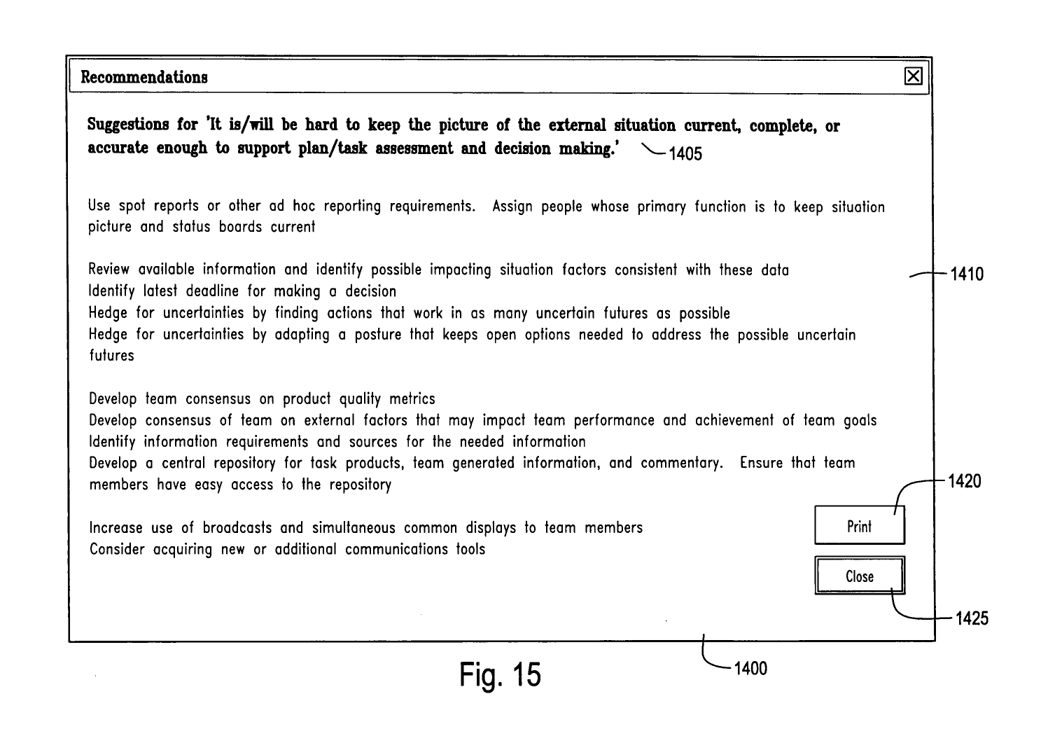

The items listed in the third portion 1355, the fourth portion 1365 and the fifth portion 1375 in FIG. 14, if selected, cause a new interface to be displayed. The new interface lists recommendations for solving problems associated with the selected item, as discussed below in connection with FIG. 15.

FIG. 15 illustrates a thirteenth exemplary embodiment of a user interface according to this invention. The graphical user interface 1400 in FIG. 15 is similar to the graphical user interface 1200 in FIG. 13 except that the graphical user interface 1400 in FIG. 15 comprises a list 1410 of recommendations for solving the problems associated with the selected item “it is not/will not be hard to keep the picture of the external situation current, complete, or accurate enough to support plan/task assessment and decision making” listed in the fourth portion 1365 in FIG. 14.

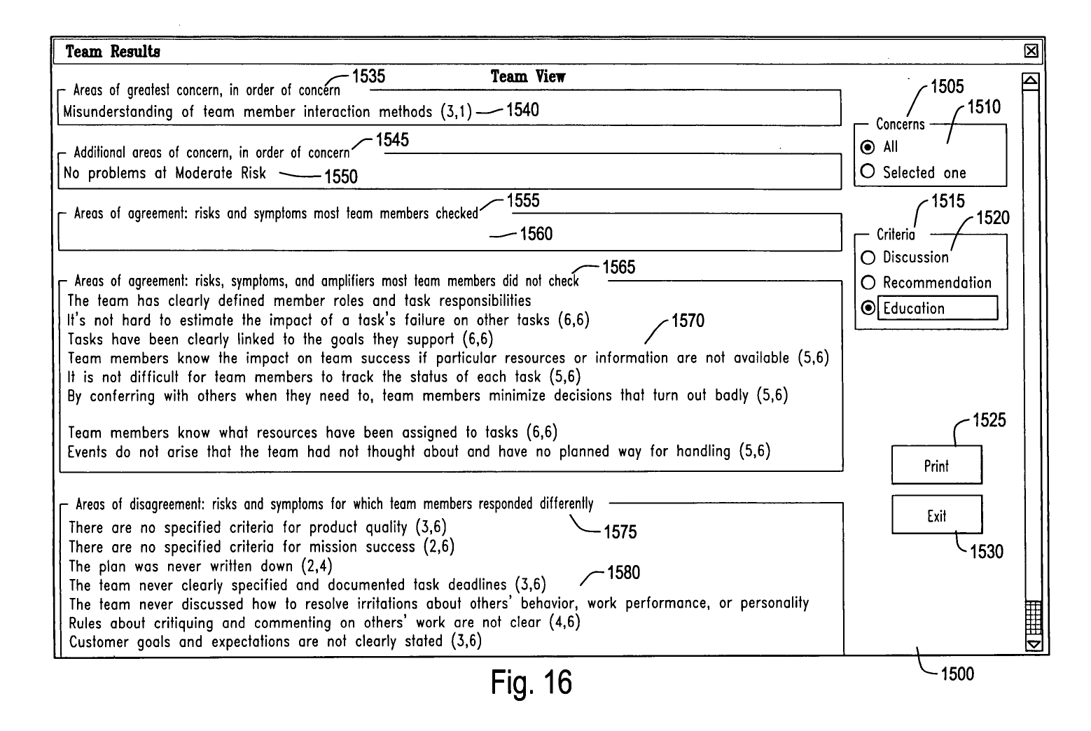

FIG. 16 illustrates a fourteenth exemplary embodiment of a user interface according to this invention. The graphical user interface 1500 is generally identical to the graphical user interface 1300 in FIG. 14 except that, in FIG. 16, the graphical user interface 1500 displays a team view that may be generated based on the education values of the questions. Accordingly, the contents of the third portion 1555, the fourth portion 1565 and the fifth portion 1575 are different from those displayed in the corresponding portions in FIG. 14.

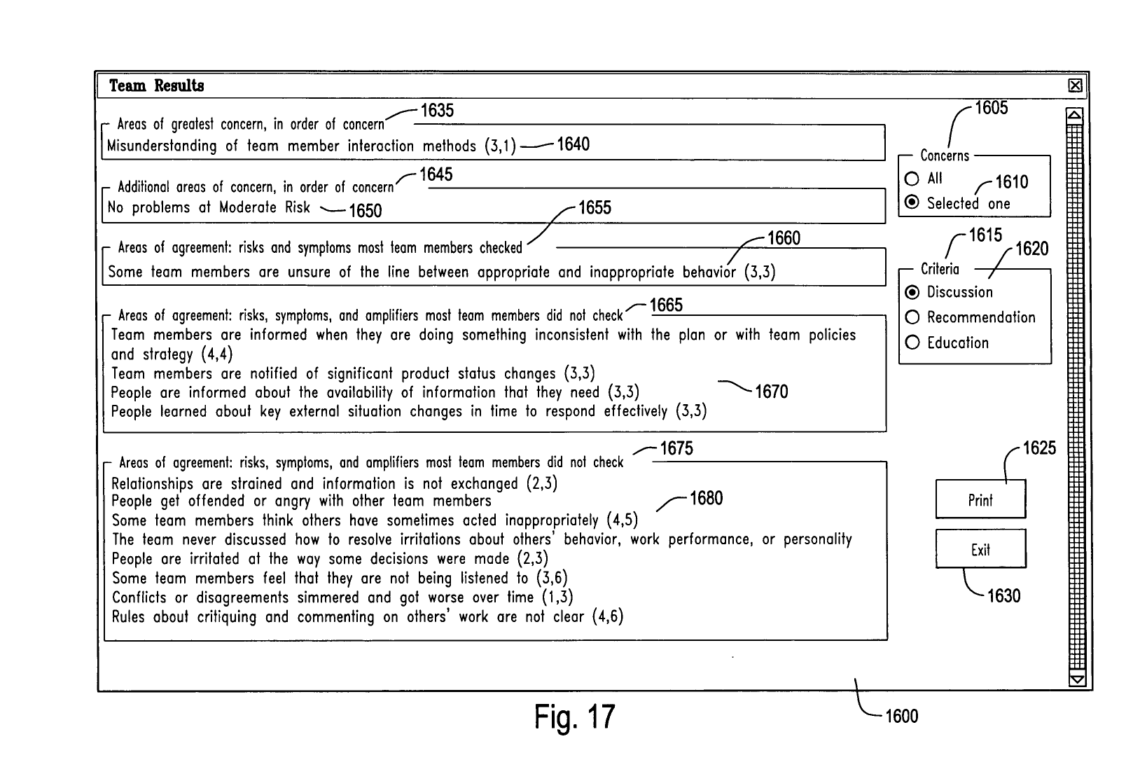

FIG. 17 illustrates a fifteenth exemplary embodiment of a user interface according to this invention. The graphical user interface 1600 is generally identical to the graphical user interface 1100 in FIG. 12, except that, in FIG. 17, the graphical user interface 1600 displays the team view created under the selection of “selected one” in the concerns selection portion 1605 (1105). Accordingly, the contents displayed in the graphical user interface 1600 are concentrated to the selected concern “misunderstanding of team member interaction methods” listed in the first portion 1635.

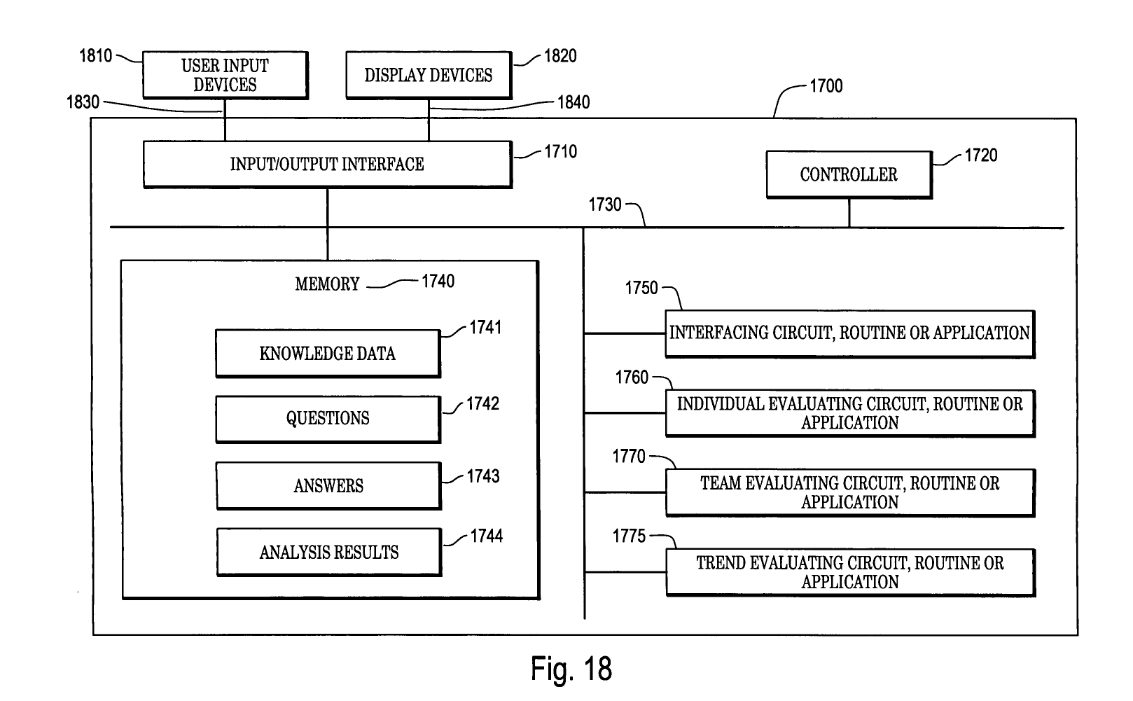

FIG. 18 is a functional block diagram of one exemplary embodiment of a collaboration evaluation system according to this invention. As shown in FIG. 18, the evaluation system 1700 includes an input/output (I/O) interface 1710, a controller 1720, a memory 1740, an interfacing circuit, routine or application 1750, an individual evaluating circuit, routine or application 1760, and a team evaluating circuit, routine or application 1770, each interconnected by one or more control and/or data busses and/or application programming interfaces 1730.

As shown in FIG. 18, the evaluation system 1700 is, in various exemplary embodiments, implemented on a programmed general-purpose computer. However, the evaluation system 1700 can also be implemented on a special-purpose computer, a programmed microprocessor or microcontroller and peripheral integrated circuit elements, an ASAIC or other integrated circuits, a digital signal processor (DSP), a hard wired electronic or logic circuit such as a discrete element circuit, a programmable logic device such as a PLD, PLA, FPGA or PAL, or the like. In general, any device capable of implementing a finite state machine that is in turn capable of implementing the flowcharts showing in FIGS. 1 and 2 can be used to implement the evaluation system 1700.

The I/O interface 1710 is designed to interact with the outside of the evaluation system 1700. In various exemplary embodiments, the I/O interface 1710 may display questions on one or more display devices 1820 connected with the I/O interface 1710 via connection 1840. The I/O interface 1710 may receive answers at one or more user input devices 1810 connected to the I/O interface 1710 via connection 1830. The one or more display devices may be a display screen, an interactive screen or the like. The one or more user input may be a mouse, a track ball, a keyboard, a joystick or the like. The one or more user input may also be dummy switches displayed on the one or more display devices.

As shown in FIG. 18, the memory 1740 includes a knowledge data portion 1741, a questions portion 1742, an answers portion 1743 and an analysis results portion 1744. The memory 1740 can be implemented using any appropriate combination of alterable, volatile or nonvolatile memory or non-alterable or fixed memory. The alterable memory, whether volatile or nonvolatile, can be implemented using any one or more of static or dynamic RAM, a floppy disk and disk drive, a writable or rewritable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or a DVD-ROM disk and disk drive or the like. The knowledge data portion 1741 stores knowledge data and evaluation values, including discussion values, recommendation values, diagnosis values, and education values, of questions to be displayed to members or uses for answers. The knowledge data can be updated based on newly acquired knowledge. The questions portion 1742 stores questions to be displayed. The questions can be updated based on newly acquired knowledge. The answers portion 1743 stores answers received from users/members. The received answers can be accumulated over time. The analysis results portion 1744 stores analyzed results based on answers from individual members or a collection of team members (team view). The answers may be provided as entered by a user and/or as retrieved from memory.

In the evaluation system 1700 shown in FIG. 18, the interfacing circuit, routine or application 1750 may retrieve questions and/or analysis results from the memory 1740 to be transferred to the input/output interface 1710 to be displayed at the one or more display devices 1820. The interfacing circuit, routine or application 1750 also may receive answers from the input/output interface 1710 and transfers the answers to the memory 1740. The individual evaluating circuit, routine or application 1760 may process answers from an individual user, using knowledge data stored in the knowledge data portion 1741, to generate analysis results based on the answers from the individual user. The team evaluating circuit, routine or application 1770 may process a collection of answers from a plurality of users and generates statistical results from the answers, using knowledge data stored at the knowledge data portion 1741, to produce or generate team view based on the collection of answers. A trend evaluating circuit, routine or application 1775 may provide an indication of one or more trends in the results of the team view relative to prior team views. In various exemplary embodiments, the trend evaluating circuit, routine or application 1775 enables users to track team changes over time. It displays changes to diagnosed team problems, identifies the particular team issues most responsible for the changes, and quantifies the change in team responses on these issues.

In various exemplary embodiments, the knowledge data comprises expert data. The expert data contains information regarding collaboration issues that may be expected to arise among team members. In various exemplary embodiments, the expert data includes information about specific types of knowledge useful in, and/or normally required for, successful collaboration of members of teams, organizations and international associations and about risks that impede these types of knowledge, symptoms of knowledge deficiencies of such knowledge, circumstances that affect the importance of the knowledge, and about recommendations that improve the knowledge. The systems and methods according to this invention takes into consideration the observed behaviors, actions, successes and failures, and motivations of team members in handling various situations, such as crises and emergencies.

In various exemplary embodiments, the knowledge data comprises information regarding goal understanding by team members. The goal understanding information may contain knowledge regarding what a customer wants, an understanding of a team mission, the goals of a commander, and the criteria for evaluating team success. In various exemplary embodiments, the goal understanding information may contain the knowledge of understanding both the explicit and implied goals and motivations of a team, taking into consideration of the culture norms of the tasking authority.

In various exemplary embodiments, the knowledge data comprises information regarding understanding of roles, tasks and schedule(s) of team members. The information regarding understanding of roles, tasks and schedule may include knowing who is supposed to do what and when, and with what information and resources. It may include understanding what tasks a plan has specified for accomplishing the team goals, people and resources assigned to each task, information requirements, who provides task backups, when various tasks need to be completed, plan assumptions and contingencies, and criteria for evaluating task progress and changing the plan.

In various exemplary embodiments, the knowledge data may comprise information regarding understanding team member relationships and inter- dependencies, as well as team goals and tasks. The relationship and dependencies information may contain knowledge regarding how entities, events and tasks impact the a team plan of action. The relationship and dependencies information may be based on understanding of the temporal, spatial and causavor logical relationships between separate tasks and between tasks and goals, information, resources and the external situation. The relationship and dependencies information may be based on the understanding of team member dependencies to enable team members to predict how performance on one task will impact other tasks and achievement of goals.

In various exemplary embodiments, the knowledge data may comprise information about understanding other team members and non-team members. The information for understanding others may contain knowledge regarding other team members' backgrounds, capabilities and preferences, and may include knowledge of knowing others' knowledge, values, decision criteria, likes and dislikes, resourcefulness, persistence, leadership ability and ability to work with others.

In various exemplary embodiments, the knowledge data may comprise information regarding understanding of team “business rules.” The business rules information may contain knowledge regarding effective and agreed upon rules for team members to interact with each other. Business rules information may contain both formal and unspoken rules, including rules for team decision processes and problem solving, for interacting with team leaders, for sharing information, for the way people meet, talk, listen, brainstorm and hear outside perspectives, for providing feedback about others' behaviors and performance, for creating and editing others' work and products, for offering/asking for help and information and for setting up meetings, such as, for example, how to schedule and who to invite.

In various exemplary embodiments, the knowledge data may comprise information regarding task skills. The task skill information may contain knowledge regarding how to do one's assigned work, including knowing how to perform assigned tasks, how to find and access document information, how to use support tools, and how to find and access useful resources including, for example, people with useful knowledge.

In various exemplary embodiments, the knowledge data may comprise information regarding activity awareness. The activity awareness information may contain knowledge regarding what others are doing now and the current need for doing it, including knowing tasks people are working on, how busy they are, their level of engagement, how well they are doing, and whether these activities effectively support team goals.

In various exemplary embodiments, the knowledge data may comprise information regarding understanding of the external situation. The external situation information may contain knowledge regarding the status of people, things and events of the world outside of the team and projecting future changes. In the context of military operations, the external situation information may include the adversary, local populations and the weather of hostile cities. In the context of business, the external situation information may include the actions of competitors, the preferences of customers, the economy and national policies. The external situation information may include knowing who the significant players are and knowing their status, capabilities, strengths, weaknesses, behaviors, objectives and plans.

In various exemplary embodiments, the knowledge data may comprise information regarding current task assessment. The current task assessment information may contain knowledge for keeping tasks on track, knowing how well own and others' tasks are progressing, and when to offer help, including knowing what tasks are being worked on and by whom, the status of these tasks, the status of required information and the resources, comparison of this status with the status called for by the plan, judgment of the adequacy of the available information and resources and the projection of task success. The current task assessment information may include an estimate of whether a task needs help and an estimate of whether the required resources and the information are available.

In various exemplary embodiments, the knowledge data may comprise team member mutual understanding information. The mutual understanding information may contain knowledge regarding what other team members understand now and knowing if they agree or disagree. The mutual understanding information addresses the extent to which team members know how well they are being understood. The mutual understanding information may include the extent to which team members are aware of where and why they agree or disagree about team goals, the plan, business rules, team progress, the internal situation and anything else that can impact team performance. The mutual understanding information may contain knowledge of minimizing misunderstanding between people.

In various exemplary embodiments, the knowledge data may comprise plan assessment information. The plan assessment information may contain knowledge regarding whether a plan will still enable the team to achieve its goals. The plan assessment information may provide longer team inter-task projection of future resources and information status and of the success of future tasks, and build on and integrates assessments of team activities, current task progress, the external situation and degree of mutual understanding. The plan assessment information may provide knowledge regarding the environment, resource and information assumptions of a plan, and projecting whether these assumptions will hold in the future. The plan assessment may contain information regarding considerations of all current and future tasks when estimating the need for plan adjustments.

In various exemplary embodiments, the knowledge data may comprise information for understanding decision drivers. The decision drivers information may contain knowledge for assessing and applying the criteria for selecting an action, including knowledge for knowing when a decision needs to be made, and knowledge regarding extracting from information and assessments those factors relevant to making specific decisions, including the status and projections of planned tasks, resources, information, external involvement, and team members' spirit. The decision drivers information may include assessing factors that impact how a decision is to be made, such as the stakes, level of uncertainty, requirement to confer with other team members and shareholders, and knowledge of time available and of decision trigger points/events. Information in the knowledge base may be obtained from numerous sources including, for example, case studies relating to team collaboration, academic research relating to team collaboration, including information relating to both successful and unsuccessful team collaboration, command and control research, military doctrine, and both patent and non-patent literature concerning group member interaction.

In an exemplary operation in which the evaluation system evaluates a collaboration level according to this invention, the interfacing circuit, routine or application 1750, under control of the controller 1720, may display, at the one or more display devices 1820, a plurality of questions stored in and retrieved from the questions portion 1742. The interfacing circuit, routine or application 1750, under control of the controller 1720, may receive, via the input/output interface 1710, answers an individual user inputs at the one or more user input devices 1810. The interfacing circuit, routine or application 1750 may transfer the answers to the answers portion 1743.

The individual evaluating circuit, routine or application 1760, under control of the controller 1720, may determine whether more questions should be displayed based on the received answers from the single user for more answers, and retrieves or generates additional questions. The interfacing circuit, routine or application 1750, under the control of the controller 1720, may display the additional questions at the one or more display devices 1820.

The individual evaluating circuit, routine or application 1760, under control of the controller 1720, may process the answers received from the user, using knowledge data stored in the knowledge data portion 1741, to generate evaluation results and to store the evaluation results in the analysis results portion 1744. The interfacing circuit, routine or application 1750, under the control of controller 1720, may transfer the evaluation results to the input/output interface 1710. The input/output interface 1710 may be used to display the evaluation results at the one or more display devices 1820.

The interfacing circuit, routine or application 1750, under control of the controller 1720, may receive requests from the user at the one or more user input devices 1810 for interactively reviewing different aspects/levels of the evaluation results, by accessing the analysis results 1744 for the requested aspect/level of evaluation results to be displayed at the one or more display devices 1820.

In another exemplary embodiment, the evaluation system may evaluate a collaboration level based on a collection of answers from a plurality of members, wherein the team evaluating circuit, routine or application 1770 retrieves answers from the answers portion 1743. The answers may be previously or currently received. The team evaluating circuit, routine or application 1770, under control of the controller 1720, may process the answers and generates statistical results from the answers, using knowledge data stored in the knowledge data portion 1741, to provide or generate team view based on the collection of answers.

The interfacing circuit, routine or application 1750, under control of the controller 1720, may transfer the team view to the input/output interface 1710 to be displayed at the one or more display devices 1820. The interfacing circuit, routine or application 1750, under control of the controller 1720, may receive requests at the one or more user input devices 1810 regarding reviewing different aspects/levels of the team view. In response, the interfacing circuit, routine or application 1750, under control of the controller 1720, may retrieve or otherwise generate the requested aspect/level of the team view based on the statistical results and/or the evaluation analysis results.

While this invention is being described in conjunction with the exemplary embodiments outlined above, it is evident that many alternative modifications and variations will be apparent to those skilled in the art. Accordingly, the exemplary embodiments of the invention set forth above are intended to be illustrative, not limiting. Various changes may be made without departing from the spirit and scope of the invention.

1. A method for evaluating a collaboration level among a plurality of team members, the method comprising:
providing one or more topics of concern to the collaboration level;
providing one or more facets or aspects and/or characteristics of the one or more topics in the form of one or more selectable choices or answers;
receiving from one of the plurality of team members a selection of one or more choices or answers; and
generating collaboration advice based on knowledge data and the selection of the one or more choices or answers, the knowledge data comprising one or more evaluation values for each of the one or more choices and collaboration level information associated with each of the one or more choices.

2. The method according to claim 1, wherein generating collaboration advice comprises generating at least one of a diagnosis, a warning sign, a risk assessment, a process suggestion and a tools suggestion.

3. The method of claim 1, further comprising updating the knowledge data.

4. The method of claim 1, wherein the evaluation value comprises at least one of a diagnosis value, a discussion value, a recommendation value and an education value.

5. A method for evaluating a collaboration level among team members that comprise at least a first member and a second member, the method comprising:
providing one or more topics of concern to the collaboration level;
providing one or more aspects, facets and/or characteristics of each of the one or more topics in the form of one or more selectable choices or answers;
receiving from the first member a first selection of the one or more choices or answers;
receiving from the second member a second selection of the one or more choices or answers; and
generating a team-view based on knowledge data and the first and second selections of the one or more choices or answers, the team-view comprising statistic analysis of the first and second selections of the one or more choices or answers, the knowledge data comprising an evaluation value for each of the one or more choices or answers and collaboration level information associated with each of the one or more choices or answers.

6. The method of claim 5, wherein generating a team view comprises generating at least one of a list of concerns agreed by team members, a list of concerns disagreed by members and a list of recommendations in response to a concern in the list of agreed or disagreed concerns.

7. The method of claim 5, further comprising updating the knowledge data.

8. The method of claim 5, wherein the evaluation value comprises at least one of a diagnosis value, a discussion value, a recommendation value and an education value.

9. A computer storage medium having executable software code for evaluating a collaboration level among a plurality of team members, the executable software code including:
instructions for providing one or more choices or answers relating to topics of concern to the collaboration level;
instructions for providing one or more choices or answers of the one or more topics;
instructions for receiving from one of the plurality of team members a selection of the one or more aspects, facets and/or characteristics; and
instructions for generating collaboration advice based on knowledge data and the selection of the one or more choices or answers, the knowledge data comprising an evaluation value for each of the one or more topics and collaboration level information associated with each of the one or more choices or answers.

10. The computer storage medium of claim 9, wherein the instructions for generating collaboration advice comprise instructions for generating at least one of a diagnosis, a warning sign, a risk assessment, a process suggestion and a tools suggestion.

11. The computer storage medium of claim 9, further comprising instructions for updating the knowledge data.

12. The computer storage medium of claim 9, wherein the evaluation value comprises at least one of a diagnosis value, a discussion value, a recommendation value and an education value.

13. A computer storage medium having executable software code for evaluating a collaboration level among team members that comprises at least a first member and a second member, the executable software code including:
instructions for providing one or more topics or issues of concern to the collaboration level;
instructions for providing one or more choices or answers to each of the one or more topics or issues;
instructions for receiving from the first member a first selection of the one or more choices or answers, and for receiving from the second member a second selection of the one or more choices or answers; and
instructions for generating a team-view based on knowledge data and the first and second selections of the one or more choices or answers, the team-view comprising statistic analysis of the first and second selections of the one or more choices or answers, the knowledge data comprising an evaluation value for each of the one or more topics and collaboration level information associated with each of the one or more choices or answers.

14. The computer software medium of claim 13, wherein the instructions for generating a team-view comprise instructions for generating at least one of a list of concerns agreed by team members, a list of concerns disagreed by team members and a list of recommendations in response to a concern in the list of agreed or disagreed concerns.

15. The computer storage medium of claim 13, further comprising instructions for updating the knowledge data.

16. The computer storage medium of claim 13, wherein the evaluation value comprises at least one of a diagnosis value, a discussion value, a recommendation value and an education value.

17. A system for evaluating a collaboration level among a plurality of team members, comprising:
an interfacing circuit, routine or application;
an individual evaluating circuit, routine or application; and
a database that stores one or more topics of concern to the collaboration level, one or more choices or answers relating to each of the one or more topics, and knowledge data comprising an evaluation value for each of the one or more topics and collaboration level information associated with each of the one or more choices or answers,
wherein:
the interfacing circuit, routine or application displays the one or more topics and the one or more aspects, facets and/or characteristics, and receives from one of the plurality of team members a selection of the one or more aspects, facets or characteristics; and
the individual evaluating circuit, routine or application generates collaboration advice based on the knowledge data and the selection of the one or more aspects, facets and/or characteristics.

18. The system of claim 17, wherein the individual evaluating circuit, routine or application generates at least one of a diagnosis, a warning sign, a risk assessment, a process suggestion and a tools suggestion.

19. The system of claim 17, wherein the interfacing circuit, routine or application updates the knowledge data.

20. The system of claim 17, wherein the evaluation value comprises at least one of a diagnosis value, a discussion value, a recommendation value and an education value.

21. A system for evaluating a collaboration level among team members that comprises at least a first member and a second member, the system comprising:
an interfacing circuit, routine or application;
a team evaluating circuit, routine or application; and
a database that stores one or more topics of concern to the collaboration level, one or more aspects, facets and/or characteristics of the one or more topics, and knowledge data comprising an evaluation value for each of the one or more topics and collaboration level information associated with each of the one or more aspects, facets and/or characteristics,
wherein:
the interfacing circuit, routine or application displays the one or more topics and the one or more choices or answers, receives from the first member a first selection of the one or more choices or answers, and receives from the second member a second selection of the one or more choices or answers; and
the team evaluating circuit, routine or application generates a team-view based on the knowledge data and the first and second selections of the one or more choices or answers, the team-view comprising statistic analysis of the first and second selections of the one or more choices or answers.

22. The system of claim 21, wherein the team evaluating circuit, routine or application generates a least one of a list of concerns agreed by team members, a list of concerns disagreed by team members, and a list of recommendation in response to a concern in the list of agreed or disagreed concerns.

23. The system of claim 21, wherein the interfacing circuit, routine or application updates the knowledge data.

24. The system of claim 21, wherein the evaluation value comprises at least one of a diagnosis value, a discussion value, a recommendation value and an education value.
